(19) United States
(12) Patent Application Publication
(10) Pub. No.: US 2014/0326672 A1
(43) Pub. Date: Nov. 6, 2014

(54) MELAMINE ALDEHYDE POLYMERS

(71) Applicant: Agency for Science, Technology and Research, Singapore (SG)

(72) Inventors: Yugen Zhang, Singapore (SG); Mei Xuan Tan, Singapore (SG); Jackie Y. Ying, Singapore (SG)

(21) Appl. No.: 14/361,463

(22) PCT Filed: Nov. 29, 2012
(86) PCT No.: PCT/SG2012/000449

§ 371 Date: May 29, 2014

(30) Foreign Application Priority Data
Nov. 29, 2011 (SG) 201108838-2

(51) Int. Cl. B01J 20/30; C08G 12/32; B01D 15/20; B01D 15/38; B01J 20/28; C02F 1/28

(52) U.S. Cl. CPC B01J 20/3085; B01J 20/28083; C02F 1/285; B01D 15/203; B01D 15/3804; B01J 20/28076; C08G 12/32; C02F 2101/20
USPC 210/670; 210/502.1; 210/483; 210/489; 210/660; 528/254

(57) ABSTRACT

Described herein is a melamine-aldehyde polymer, wherein the polymer has a pore volume in the range of about 1.5 to 5 cm3/g.

### TECHNICAL FIELD

The present disclosure relates to polymers useful as liquid purification agents.

### BACKGROUND

Many industries produce large amounts of wastewater that contain hazardous amounts of mercury, lead, cadmium, silver, copper, and zinc ions. Heavy metal contamination poses serious threats to public health and the environment. Exposure to contaminated water can be harmful even at very low metal contaminant concentrations. Industries are required by law to reduce the concentrations of metal contaminants in their wastewater before discharging it into public water systems. However, existing technology can be expensive and/or inadequate to meet new and more stringent regulatory requirements for maximum tolerated wastewater levels.

The toxicities of heavy metals are well known. Lead(II), for example, can lead to brain damage and dysfunction of kidneys, liver and central nervous system in humans, especially in children. Contaminated drinking water is a particular concern, and hence the maximum acceptable concentrations of toxic metals in drinking water are set at very low levels globally.

The European Community Directive 98/83 and the World Health Organization (WHO) guidelines reduce the lead limit in tap water from 50 ppb to 10 ppb by December 2013.

The U.S. Environmental Protection Agency (EPA) sets the action level at 15 ppb, and the maximum contaminant level goal for Pb in tap and drinking water at zero, in recognition of the deleterious health effects associated with low Pb concentrations.

Cadmium is another toxic metal of environmental concern; it causes kidney, liver and lung damage, and is a probable human carcinogen for lung and hormone-related cancers.

Significant efforts have been devoted towards, the development of new technology for water treatment. However, inexpensive, efficient, safe, and rapid removal of metal contaminants from water remains a major challenge.

Various technologies, such as precipitation, adsorption, chelation, ion-exchange and reverse osmosis, have been developed to treat water contaminated with metal species.

The removal of toxic metals from aqueous streams has traditionally been accomplished via precipitation. In general, this method suffers from the need for long interaction time, high costs for the materials needed for precipitation, and the high cost for disposal of the precipitated material. It is also difficult to reduce the metal concentrations to very low levels by using precipitation.

Reverse osmosis techniques have been employed in certain applications to remove metal contaminants from water. However, this method is costly, nonselective (all ions are removed), and slow, which makes it unsuitable for large-scale water treatment.

Conventional ion-exchange resins are poor candidates for toxic metal removal from water, because they also indiscriminately adsorb nonhazardous ions that are abundant in water, such as Na⁺, K⁺, Mg²⁺ and Ca²⁺.

Chelating ion-exchange resins or chelating polymers are modified with specific functional groups that can selectively bind only heavy metals. These adsorbents are capable of removing toxic metals from water rapidly. However, in general, they cannot be used to decrease metals to extremely low concentrations (below 1 ppb), and their high material cost limits their large-scale use.

Accordingly, there exists a need for a cost effective, efficient, and selective means for reducing metal levels in liquids, such as water, to extremely low concentrations. The present disclosure addresses this need and has related advantages.

### SUMMARY

According to a first aspect, there is provided a melamine-aldehyde polymer, wherein the polymer has pores with a volume in the range of about 1.5 to 5 cm³/g

According to a second aspect, there is provided a method of reducing the amount of a metal in a liquid sample, the method comprising the step of contacting the liquid sample with a melamine-aldehyde polymer as described herein thereby forming a polymer metal complex and a purified liquid sample, wherein the amount of the metal in the purified liquid sample is lower than the amount of metal in the liquid sample.

According to a third aspect, there is provided a method for preparing a melamine-aldehyde polymer as described herein, the method comprising the step of contacting melamine with an aldehyde thereby forming the polymer as described herein.

As will be discussed in greater detail below, the melamine-aldehyde polymers provided herein have a very high affinity for metals (e.g., metals and metal ions), which enables the polymers to form strong metal complexes upon contact with liquids containing one or more metals. The strong affinity of the melamine-aldehyde polymers can be used to remove metals, such as lead, copper, cadmium, and palladium from liquids, such as water.

Advantageously, the melamine-aldehyde polymers described herein are chemically stable under liquid treatment conditions, have a high metal binding capacity (over 600 μg/g), demonstrate very strong affinities for metals, and can be recycled. The melamine-aldehyde polymers can be used to efficiently remove metal contaminants to extremely low concentrations (<0.1 ppb) even under very short treatment times.

### DEFINITIONS

The following words and terms used herein shall have the meaning indicated:

As used herein, the term “alkyl group” includes within its meaning monovalent (“alkyl”) and divalent (“alkylene”) straight chain or branched chain saturated aliphatic groups having from 1 to 10 carbon atoms, eg, 1, 2, 3, 4, 5, 6, 7, 8, 9, or 10 carbon atoms. For example, the term alkyl includes, but is not limited to, methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl, and the like.

The term “alkenyl group” includes within its meaning monovalent (“alkenyl”) and divalent (“alkenylene”) straight or branched chain unsaturated aliphatic hydrocarbon groups having from 2 to 10 carbon atoms, eg, 2, 3, 4, 5, 6, 7; 8, 9, or 10 carbon atoms and having at least one double bond, of either E, Z, cis or trans stereochemistry where applicable, anywhere in the alkyl chain. Examples of alkenyl groups include but are not limited to ethenyl, vinyl, allyl, 1-methylvinyl, 1-propenyl, 2-propenyl, 2-methyl-1-propenyl, 2-methyl-1-propenyl, 1-butenyl, 2-butenyl, 3-butentyl, 1,3-butadienyl, 1-pentenyl, 2-pententyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 2-heptentyl, 3-heptenyl, 1-octenyl, 1-nonenyl, 1-decenyl; and the like.

The term “alkynyl group” as used herein includes within its meaning monovalent (“alkynyl”) and divalent (“alkynylene”) straight or branched chain unsaturated aliphatic hydrocarbon groups having from 2 to 10 carbon atoms and having at least one triple bond anywhere in the carbon chain. Examples of alkynyl groups include but are not limited to ethynyl, 1-propynyl, 1-butynyl, 2-butynyl, 1-methyl-2-butynyl, 3-methyl-1-butynyl, 1-pentynyl, 1-hexynyl, methylpentynyl, 1-heptynyl, 2-heptynyl, 1-octynyl, 2-octynyl, 1-nonyl, 1-decynyl, and the like.

The term “cycloalkyl” as used herein refers to cyclic saturated aliphatic groups and includes within its meaning monovalent (“cycloalkyl”), and divalent (“cycloalkylene”), saturated, monocyclic, bicyclic, polycyclic or fused polycyclic hydrocarbon radicals having from 3 to 10 carbon atoms, eg, 3, 4, 5, 6, 7, 8, 9, or 10 carbon atoms. Examples of cycloalkyl groups include but are not limited to cyclopropyl, 2-methylcyclopropyl, cyclobutyl, cyclopentyl, 2-methylcyclopentyl, 3-methylcyclopentyl, cyclohexyl, and the like.

The term “aromatic group”, or variants such as “aryl” or “arylene” as used herein refers to monovalent (“aryl”) and divalent (“arylene”) single, polynuclear, conjugated and fused residues of aromatic hydrocarbons having from 6 to 10 carbon atoms. Examples of such groups include phenyl, biphenyl, naphthyl, phenanthrenyl, and the like.

The term “aralkyl” as used herein, includes within its meaning monovalent (“aryl”) and divalent (“arylene”), single, polynuclear, conjugated and fused aromatic hydrocarbon radicals attached to divalent, saturated, straight and branched chain alkylene radicals.

The term “optionally substituted” as used herein means the group to which this term refers may be unsubstituted, or may be substituted with one or more groups independently selected from alkyl, alkenyl, alkynyl, thioalkyl, cycloalkyl, cycloalkenyl, heterocycloalkyl, halo, carboxyl, haloalkyl, haloalkynyl, hydroxyl, alkoxy, thioalkoxy, alkenyloxy, haloalkoxy, haloalkenyloxy, nitro, amino, nitroalkyl, nitroalkenyl, nitroalkynyl, nitroheterocyclyl, alkylamino, dialkylamino, alkenylamine, alkynylamino, acyl, alkenoyl, alkynoyl, acylamino, diacylamino, acyloxy, alkylsulfonyloxy, heterocycloxy, heterocycloamino, haloheterocycloalkyl, alkylsulfenyl, alkylcarbonyloxy, alkylthio, acylthio, phosphorus-containing groups such as phosphono and phosphinyl, aryl, heteroaryl, alkylaryl, alkylheteroaryl, cyano, cyanate, isocyanate, —C(O)NH(alkyl), and —C(O)N(alkyl)₂.

As used herein, the term “purified” or “to purify” refers to the removal of at least a portion of one or more impurities, contaminants, and/or undesired materials from a sample. For example, a liquid sample containing an undesired amount of lead is purified by removing at least some or substantially all of the lead present in the liquid sample. The purified liquid sample will have a lower amount of the undesired Pb than the initial liquid sample.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 4, 5, and 6. This applies regardless of the breadth of the range.

### DISCLOSURE OF OPTIONAL EMBODIMENTS

Exemplary, non-limiting embodiments of a melamine-aldehyde polymer, a method for reducing the amount of a metal in a liquid, and a process for preparing a melamine-aldehyde polymer will now be disclosed.

The melamine-aldehyde polymers described herein can be represented by the idealized structure shown below:

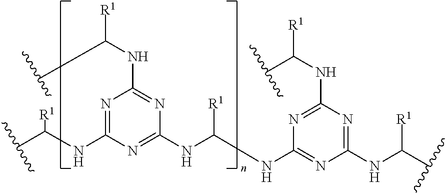

wherein n is a whole number greater than 2 and R¹ can be hydrogen, alkyl, cycloalkyl, alkenyl, cycloalkenyl, alkynyl, aryl, aralkyl, heterocycloalkyl, or heteroaryl.

R¹ can be hydrogen, methyl, ethyl, propyl, butyl, pentyl, or hexyl. In the examples below, R¹ is hydrogen.

The average molecular weight of the melamine-aldehyde polymer can be from about 500 Da to about 2,000 KDa. N can be a whole number selected from any number in the range of 2-100,000.

Advantageously, the numerous amino groups present on the polymerized triazine structures are capable of providing a broad range of binding modes and can function as, e.g., mono-dentate, di-dentate, tri-dentate, and/or tetra-dentate metal chelating groups enabling the melamine-aldehyde polymers to coordinate and bind to different types of metal species.

Despite the broad range of metals that the melamine-aldehyde polymers can strongly coordinate, the polymers exhibit a surprisingly low affinity to Group I and Group II metals, such as sodium, potassium, and calcium. As a result, the melamine-aldehyde polymers can be used to selectively remove heavy metal contaminants, such as cadmium, copper, lead, and palladium, from a liquid sample, such as water, without appreciably effecting the concentration of desirable metal species, e.g., calcium, potassium, and sodium.

The binding of metal species to the melamine-aldehyde polymer can be further facilitated by the extremely high surface area of the polymer. The melamine-aldehyde polymers described herein can have a Brunauer-Emmett-Teller (BET) surface areas greater than about 400 cm²/g, which greatly increases the affinity and binding capacity of the resin. The BET surface area of the resins can be from about 400 cm²/g to about 2000 cm²/g, about 400 cm²/g to about 1800 cm²/g, about 400 cm²/g to about 1600 cm²/g, about 400 cm²/g to about 1400 cm²/g, about 400 cm²/g to about 1200 cm²/g, or about 500 cm²/g to about 1100 cm²/g.

The melamine aldehyde polymers can have an open pore structure, which allows access, via pores, to metal binding sites below the surface of the polymeric material.

The melamine-aldehyde polymer can be mesoporous, i.e., contain pores with diameters between 2 to 50 nm. In certain cases, the melamine-aldehyde can have pore sizes below about 50 nm in size. The pore size of the melamine-aldehyde polymer can range from about 1 nm to about 30 nm, about 1 nm to about 25 nm, about 1 nm to about 20 nm, about 5 nm to about 20 nm, and combinations thereof. The melamine-aldehyde polymer can have pore sizes in the range of about 2 nm to about 40 nm.

The average pore size of the melamine-aldehyde polymer can range from about 1 nm to about 30 nm, about 1 nm to about 25 nm, about 1 nm to about 20 nm, about 5 nm to about 20 nm, about 10 nm to about 20 nm, about 10 nm to about 18 nm, about 10 nm to about 16 nm, or about 12 nm to about 15 nm.

The pores of the melamine-aldehyde polymer can have a volume in the range of about 1-7 cm³/g, about 1-5 cm³/g, about 1-4 cm³/g, about 1-3 cm³/g, about 1.5-2.5 cm³/g, and combinations thereof. The melamine-aldehyde polymer can have pores with volumes in the range of about 1.5 to 5 cm³/g.

The average pore volume of the melamine-aldehyde polymers described herein can be 1 to 6 cm³/g, 1 to 5 cm³/g, 1 to 4 cm³/g, 1 to 3 cm³/g, 1.5 to 3 cm³/g, 2 to 3 cm³/g, or 2 to 2.5 cm³/g.

The melamine-aldehyde polymers can be prepared by the copolymerization of an aldehyde and 1,3,5-triazine-2,4,6-triamine.

The melamine-aldehyde polymers can be prepared by the solvothermal reaction of melamine and the aldehyde. Typical solvothermal conditions call for the reaction to be conducted at elevated temperature and pressure. In certain instances, the reaction can be conducted below, at, or above the boiling point of the solvent.

The reaction can be conducted in a closed system, such as an autoclave, bomb, or other suitable high pressure reaction vessel.

The pressure of the reaction vessel can be autogeneous and dependent on the head space in the reaction vessel, the reaction temperature, and the boiling point of the reaction solvent; or controlled externally by application of pressure by suitable means.

The use of solvothermal conditions allows the preparation of melamine-aldehyde polymers with high porosity and BET surface area.

The reaction pressure can be from about 100 kPa to about 1000 kPa, about 100 kPa to about 900 kPa, about 100 kPa to about 800 kPa, about 100 kPa to about 700 kPa, about 100 kPa to about 600 kPa, about 100 kPa to about 500 kPa, about 100 kPa to about 400 kPa, about 100 kPa to about 300 kPa, or about 100 kPa to about 200 kPa.

The reaction temperature can be from 100° C. to about 250° C., about 100° C. to about 200° C., about 130° C. to about 200° C., about 150° C. to about 190° C., or about 140° C. to about 180° C.

The reaction can be conducted at a temperature greater than 100° C. and a pressure greater than 100 kPa. In certain instances, the temperature can be in the range of about 140° to 180° C. and the temperature can be in the range of 100 kPa to 200 kPa.

A polar aprotic solvent can be used in the preparation of the melamine-aldehyde polymers. Suitable, polar aprotic solvents include, but are not limited to dimethylacetamide (DMA), dimethylformamide (DMF), dimethylsulfoxide (DMSO), sulfolane, N-methyl-2-pyrrolidone (NMP), hexamethylphosphoramide (HMPA), 1,3-dimethyl-3,4,5,6-tetrahydro-2(1H)-pyrimidinone (DMPU), 1,3-dimethyl-2-imidazolidinone (DMI), and combinations thereof.

Any aldehyde can be used in the preparation of the melamine-aldehyde polymer. Suitable aldehydes include, but are not limited to C1-C20 straight chain, branched, or cyclic aliphatic aldehydes, C2-C20 straight chain, branched, or cyclic alkenyl aldehydes, C2-C20 straight chain, branched, or cyclic alkynyl aldehydes, C6-C14 aromatic aldehydes, and C4-C14 heteroaromatic aldehydes. Exemplary aldehydes include, but are not limited to formaldehyde or a formaldehyde equivalent, such as paraformaldehyde, acetaldehyde, propanal, butanals, pentanals, hexanals, cyclopentanecarbaldehyde, cyclohexanecarbaldehyde, benzaldehyde, tolualdehydes, and furfurals.

Aldehyde equivalents, such as acetals, hemiacetals, aminals, geminal diols, and 1,3,5 trioxanes can be substituted for the aldehyde in the preparation of the melamine-aldehyde polymers.

The aldehyde can be formaldehyde or a formaldehyde equivalent, such as paraformaldehyde, formaldehyde monohydrate, trioxin, and formalin.

The melamine and aldehyde can be copolymerized in a molar ratio of about 1:4 to about 1:1. The molar ratio of melamine can be from about 1:3 to about 1:1, about 1:2.5 to about 1:1, about 1:2.5 to about 1:1.5, about 1:2.5 to about 1:1.6, or about 1:2 to about 1:1.6. In the examples below the molar ratio of melamine to aldehyde used to prepare the melamine-aldehyde polymers is 1:1.8. In certain embodiments, the polymer comprises melamine and formaldehyde in a molar ratio of about 1:1.5 to about 1:2.

The melamine and aldehyde are typically allowed to react for about 1 hour to about 100 hours. Reaction times can range from about 24 hours to about 96 hours, or about 48 hours to 72 hours.

In the examples below, the melamine-aldehyde polymers were synthesized via a simple, one-step solvothermal synthesis protocol using melamine and paraformaldehyde. In the examples, the melamine-formaldehyde polymers were prepared in an acid digestion bomb with melamine and paraformaldehyde in anhydrous DMSO at 170° C. for 72 hours. The resulting polymer was crushed, filtered and washed with acetone, tetrahydrofuran (THF) and CH₂Cl₂. The resulting melamine-formaldehyde polymers can have a BET surface area of 500-1,000 m²/g, a pore size of 5-20 nm, and a pore volume of 1.5-2.5 cm³/g.

The reaction product can be isolated by filtering the crude melamine-aldehyde polymer from the reaction solvent. The crude product is then optionally crushed and then can be washed with one or more organic solvents, such as acetone, dichloromethane, tetrahydrofuran, and combinations thereof.

The melamine-aldehyde polymer can then be washed with a basic aqueous solution, such as a Group I or II metal hydroxide. Suitable bases include, but are not limited to NaOH, KOH, LiOH, RbOH, and CsOH. The concentration of the base can range from 0.1 M to 12 M. In certain instances, the concentration of the base is 0.1 M to 1 M, 0.1 M to 0.8 M, 0.1 M to 0.6 M, or 0.1 M to 0.4 M, or 0.1 M to 0.3 M.

After the melamine-aldehyde polymer is washed with the basic solution, the polymer can be washed with deionized water and dried in a vacuum oven.

The subject melamine-aldehyde polymers have been found to be useful in the removal of metals from liquids. Methods of purification of liquids with the subject melamine-aldehyde polymer include absorption, adsorption, chelation, complexation, and association of the metals present in the liquid with the melamine-aldehyde polymer. In general, the metals migrate into or onto the surface of the melamine-aldehyde polymer and bind with one or more of the nitrogenous ligands in the polymer thereby forming a purified liquid sample. The metal bound melamine-aldehyde polymer is then separated from the purified liquid. This can be accomplished in a flow-through continuous or batchwise process, using the melamine-aldehyde polymer directly or a cartridge or other vessel containing the melamine-aldehyde polymer and allowing contact with the liquid sample.

The melamine-polymer polymer can be used to reduce the amount of a metal in any liquid sample. Suitable liquid samples include aqueous liquids, organic liquids, and combinations thereof. Exemplary classes of liquid samples include, but are not limited to water, organic liquids, e.g., optionally substituted aliphatic hydrocarbons or optionally substituted aromatic hydrocarbons, and combinations thereof.

The liquid samples to be treated by the melamine-aldehyde polymer can include aqueous and non-aqueous systems, salt water, produced water, tap water, and systems containing toxic, hazardous, and/or undesirable metals. Additional non-limiting exemplars of aqueous liquid samples include groundwater, lake water, reservoir water, river water, canal water, seawater, and rainwater.

Advantageously, the melamine-aldehyde polymer is insoluble in aqueous liquids and a broad range of non-aqueous liquids and can be used by simply bringing the polymer into contact with the liquid.

Thus, the melamine-aldehyde polymer can be used directly, disposed onto a carrier suitable for liquid treatment or incorporated into a filtration device suitable for liquid treatment, or disposed onto a carrier and incorporated into a filtration device suitable for liquid treatment.

The melamine-aldehyde polymer can be used to reduce the amount of a metal in a liquid sample, such as water, by contacting the sample with the melamine-aldehyde polymer thereby forming a polymer metal complex and a purified liquid sample, wherein the amount of the metal contaminant in the purified liquid sample is lower than the amount in the liquid sample. In certain embodiments, the process further comprises separating the purified liquid sample and the polymer metal complex.

The metal can be present in the liquid sample at any concentration. For example, the metal concentration can be present in the liquid sample in an amount between about 50 ppb to about 300,000 ppb or from 0.1 ppb up to the solubility limit of the metal in the liquid sample. In other instances, the metal can be present in the liquid sample at a concentration of about 1 ppb to about 1,000 ppm, about 1 ppb to about 800 ppm, about 1 ppb to about 600 ppm, or about 1 ppb to about 400 ppm, 1 ppb to about 200 ppm, or 1 ppb to about 10 ppm.

The melamine-aldehyde polymers described herein can be used to reduce the amount of any metal in a liquid sample. The melamine-aldehyde polymers have a high affinity for transition metals and can be used to reduce the amount of any metal in Group III, Group IV, Group V, Group VI, Group VII, Group VIII, Group IX, Group X, Group XI, Group XII, Group XIII, Group XIV, Group XV, and combinations thereof in a liquid sample.

In certain instances, the metal can be a heavy metal. Suitable heavy metals include transition metals, metalloids, lanthanides, actinides, and combinations thereof.

The melamine-aldehyde polymers exhibit particularly strong affinities for palladium, cadmium, copper, and lead.

The melamine-aldehyde polymers can be used to reduce the amount of palladium, cadmium, copper, lead, and combinations thereof in a liquid sample.

The melamine-aldehyde polymers can be used to reduce the amount of metallic metals (in the 0 oxidation state) and metal ions present in reduced or oxidized form. The metal can be in the −4, −3, −2, −1, 0, +1, +2, +3, +4, +5, +6, +7, or +8 oxidation state.

As illustrated in the examples below, the pH of the liquid sample can affect the ability of the melamine-aldehyde polymer to bind to and reduce the amount of a metal in a liquid sample. The melamine-aldehyde polymers can be used at a pH of 3.8 and above. Satisfactory levels of metal reduction are realized at a pH of about 4.0, about 4.5, about 5.0, about 5.5, about 6.0, about 6.5, about 7.0, about 7.5, about 8.0, about 8.5, about 9.0, about 9.5, about 10, about 10.5, or about 11. Thus, the melamine-aldehyde polymers can be used in a pH range of about 4 to about 11, about 4 to about 10, about 4 to about 9, about 4 to about 8, about 5 to about 8, or about 5 to about 7. In the examples below, the metal reduction experiments were typically conducted at a pH of 5.5.

In certain instances, the melamine-aldehyde polymer is contacted with the liquid sample at a pH greater than about 4.

The melamine-aldehyde polymers can quickly reach equilibrium concentrations of the polymer bound metal upon contact with a liquid. As illustrated by the experiments conducted in Example 4 below, the melamine-aldehyde polymers can reduce the amount of lead in water by 99% in less than 5 seconds.

The melamine-aldehyde polymers described herein are able to quickly bind metal species upon contact with a liquid and thereby reduce the concentration of the metal in the liquid. Contact times can range from 1 second to 6 hours.

In certain instances, the melamine-aldehyde polymer is allowed to contact the liquid for at least about 20 seconds. The melamine-aldehyde polymer can contact the liquid sample for about 5 seconds, about 10 seconds, about 20 seconds, about 30 seconds, about 40 seconds, about 50 seconds, about 60 seconds, about 90 seconds, or about 120 seconds.

In cases where the liquid sample requires extended contact time with the melamine-aldehyde polymer, the liquid sample can contact the melamine-aldehyde polymer for about 30 minutes, about 1 hour, about 1.5 hours, about 2.0 hours, about 2.5 hours, about 3.0 hours, about 3.5 hours, about 4.0 hours, about 4.5 hours, about 5.0 hours, about 5.5 hours, or about 6 hours.

Upon contact with the liquid sample, the melamine aldehyde polymer can form a polymer metal complex and a purified liquid sample, wherein the amount of the metal contaminant in the purified liquid sample is lower than the amount in the liquid sample.

The purified liquid sample and the polymer metal complex can then be separated. Any method of separation known to those of skill in the art can be used and can include filtration, centrifugation, decanting, and distillation.

When the melamine-aldehyde polymer is used in a flow-through continuous process, the liquid sample can be brought into contact with and/or passed through or over the melamine-aldehyde polymer or a cartridge or other vessel containing the melamine-aldehyde polymer.

Metal containing liquid samples that have been purified by contact with the melamine-aldehyde polymers described herein can exhibit a reduction in metal content by as much as 99.99%. Depending on the initial amount of metal in the liquid sample and the amount of melamine-aldehyde polymer brought into contact with the liquid sample the metal content of the sample can be reduced by 0.01% to 99.99%.

The liquid sample can contain any amount of metal. In certain embodiments, the amount of metal in the liquid sample is in an amount of at least 1 ppb. In certain embodiments, the amount of metal in the liquid sample is in an amount between 50 ppb to about 300,000 ppb.

The metal in the liquid sample cane be reduced by about 60% to about 99.99% after the step of contacting the liquid sample with the polymer as described herein.

The melamine-aldehyde polymers can be used to reduce metal concentrations below 1 ppb. In certain instances, the metal content is reduced below about 50 ppb, below about 40 ppb, below about 30 ppb, below about 20 ppb, below about 10 ppb, below about 5 ppb, below about 1 ppb, below about 0.1 ppb, or below about 0.01 ppb.

The melamine-aldehyde polymers exhibit selective affinities to transition metals, metalloids, and lanthanides, actinides, and also demonstrate low binding affinities to Group I and II metals. Thus, the amount of sodium, potassium, or calcium in a liquid sample can be reduced by less than about 5% after the step of contacting the liquid sample with the polymer as described herein.

Advantageously, the polymer metal complex can be recycled by (1) treatment with an acid and (2) neutralization with a base to regenerate the melamine-aldehyde polymer. The experimental details presented in Example 6 demonstrate that the regenerated melamine-aldehyde polymers can retain substantially all of their metal binding performance with a negligible decrease in the metal binding capacity of the polymer or the equilibrium concentrations of metal achieved even after repeatedly recycling the melamine-aldehyde polymer.

Any acid can be used to recycle the polymer metal complex. Suitable acids include inorganic and organic acids.

Non-limiting examples of suitable acids useful in regenerating the melamine-aldehyde polymer from the polymer metal complex include hydrochloric acid, hydrobromic acid, sulfuric, sulfamic acid, phosphoric, nitric acid, and the like; and organic acids such as formic acid, acetic acid, trifluoroacetic acid, trichloroacetic acid, propionic acid, benzoic acid, benzene sulfonic acid, toluene sulfonic acid, and the like.

Any base can be used to neutralize the acid treated polymer metal complex. Suitable bases include inorganic and organic bases. Non-limiting examples of suitable bases include, NaOH, LiOH, KOH, CsOH, and RbOH.

Also provided is the polymer metal complex produced by the method of reducing a metal in a liquid sample as described herein. The polymer metal complex can be a melamine-aldehyde polymer as described herein, further comprising at one least one metal as defined herein, wherein the at least one metal is associated with the melamine-aldehyde polymer by absorption, adsorption, chelation, complexation, coordination, and combinations thereof.

The polymer metal complex can have a weight-weight ratio of about 0.001:1 to about 1:1, about 0.01:1 to about 1:1, about 0.1:1 to about 1:1, about 0.2:1 to about 1:1, about 0.3:1 to about 1:1; about 0.4:1 to about 1:1, about 0.5:1 to about 1:1, about 0.6:1 to about 1:1, or about 0.7:1 to about 1:1 of weight metal to weight melamine-aldehyde polymer. The polymer metal complex can have a weight-weight ratio of 0.7:1 or less of weight metal to weight melamine-aldehyde polymer. In certain instances, the weight-weight ratio of the polymer metal complex is 700 μg metal to 1 g melamine-aldehyde polymer or less.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 depicts a photoacoustic fourier transform infrared (PA-FTIR) spectrum of the melamine-formaldehyde-polymer prepared according to the procedure of Example 1.

FIG. 2 depicts a ¹³C nuclear magnetic resonance (¹³C-NMR) spectrum of the melamine-formaldehyde-polymer prepared according to the procedure of Example 1. The signal at 29.46 ppm is due to DMSO.

FIG. 3 depicts the effect of solution pH on (▪) the adsorption capacity of melamine-formaldehyde polymer (μg Pb/g), (♦) the % of Pb removal by melamine-formaldehyde polymer, and (▴) the equilibrium Pb concentration (ppb) of the solution after melamine-formaldehyde polymer adsorption, i.e., the concentration of the lead remaining in solution. 0.1 g of melamine-formaldehyde polymer was stirred in 25 mL of metal solutions (100 ppb Pb) of different pH for 2 hours.

FIG. 4 depicts the relationship between equilibrium Pb concentration (0-2500 ppb of Pb) and adsorption capacity of the melamine-formaldehyde polymer. 0.1 g of melamine-formaldehyde polymer was introduced to 25 mL solutions initially containing 100-5000 ppb of Pb at a pH of 5.5 for 2 hours.

FIG. 5 depicts the relationship between equilibrium Pb concentration (0-2 ppb of Pb) and adsorption capacity of the melamine-formaldehyde polymer (μg/g). 0.1 g of melamine-formaldehyde polymer was introduced to 25 mL solutions initially containing 100-5000 ppb of Pb at a pH of 5.5 for 2 hours.

FIG. 6 depicts the percentage of Pb removal and the equilibrium Pb concentration attained by the melamine-formaldehyde polymer. 0.1 g of melamine-formaldehyde polymer was introduced to 25 mL solutions of different initial Pb concentrations (0-1000 ppb) at pH=5.5, and the equilibrium Pb concentration was measured after 2 hours.

FIG. 7 depicts the kinetics of lead adsorption by melamine-formaldehyde polymer. 0.4 g of melamine-formaldehyde polymer was introduced to a 100 ppb of Pb 100 mL solution at pH=5.5 and the percent lead removal was monitored over time (0-120 minutes).

FIG. 6 depicts the kinetics of lead adsorption by melamine-formaldehyde polymer. 0.4 g of melamine-formaldehyde polymer was introduced to a 100 ppb of Pb 100 mL solution at pH=5.5 and the percent lead removal was monitored over time (0-2 minutes).

### EXAMPLES

All reagents were purchased and used in their original form unless otherwise stated. Lead, copper and cadmium solutions were prepared from lead nitrate, anhydrous copper (II) chloride and anhydrous cadmium chloride, respectively. Reagent-grade nitric acid (650), hydrochloride acid (36.5%) and anhydrous sodium hydroxide pellets were used to prepare the stock solutions. Deionized water treated by Milli-Q Synthesis A10 was used in preparing all aqueous solutions in plastic volumetric flask (PFA).

The pH of the solutions was adjusted using 0.1 M HNO₃ and 0.1 M NaOH. The pH measurements were conducted with Mettler Toledo SevenMulti pH meter calibrated with pH 4, and 10 buffer solutions. Polypropylene (PP) conical tubes of 50 mL were used for sorption experiments. Aliquots were filtered through. Cronus 13-mm 0.2-μm syringe filter. Samples were preserved in 2% HNO₃ and analyzed using Perkin Elmer SCIEX, ELAN DRC II, ICP-Mass Spectrometry.

Bismuth was used as an internal standard for lead solutions, and rhodium was used an internal standard for other metals. Calibration standards for ICP-MS were diluted with 2% HNO₃ from 10 μg/mL standards purchased from High Purity Standards, SC.

### Example 1

### Synthesis of Melamine-Formaldehyde Polymer

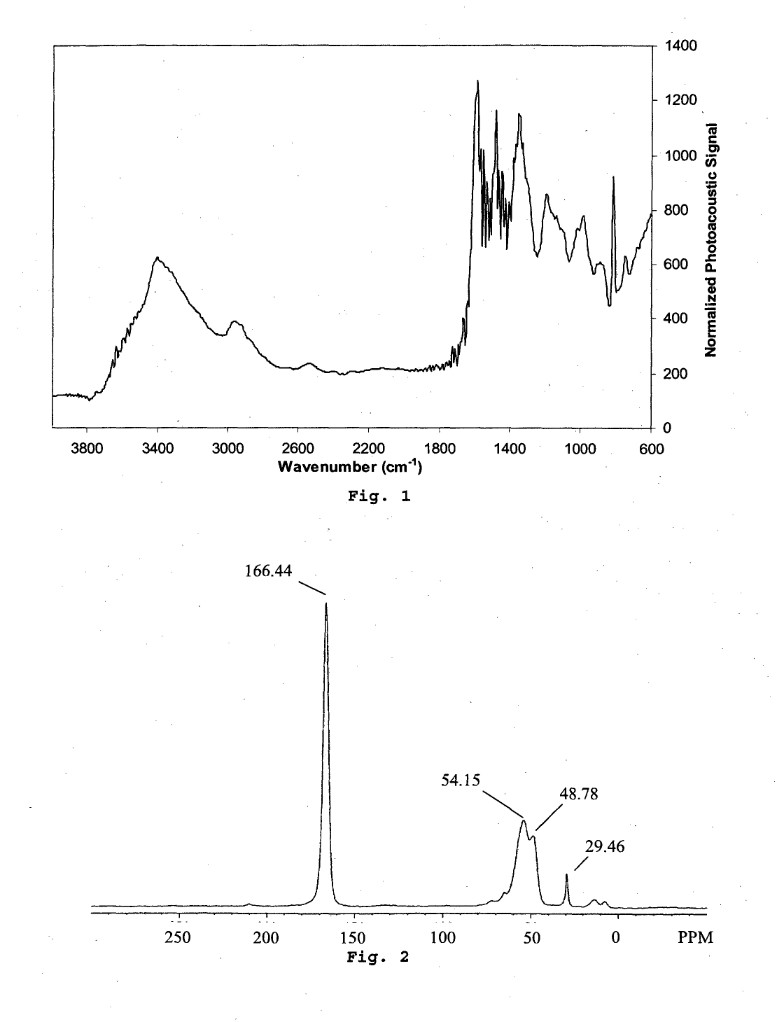

Melamine (37.5 mmol, 4.956 g) and paraformaldehyde (1.8 eq, 67.5 mmol, 2.027 g) were added to a 125 mL acid digestion bomb. Anhydrous DMSO (42 mL) was added and the reaction vessel was sealed. The reaction was heated at 170° C. for 72 hour. The reaction mixture was then allowed to cool to room temperature and the solid was crushed, filtered and washed sequentially with acetone (3×10 mL), THF (3×10 mL) and CH₂Cl₂ (10 mL). The melamine-formaldehyde polymer was isolated in greater than 95% yield. The material was characterized by infrared spectroscopy (FIG. 1.) and ¹³C-NMR (FIG. 2).

### Example 2

### Study on the Effect of pH on the Metal Binding to the Melamine-Aldehyde Polymer

Stock solutions of lead at 1000 ppm were prepared by dissolving Pb(NO₃)₂ in deionized water. 100 ppb lead solutions were prepared by further dilution from the 1000 ppm stock solution.

The pH of the metal solutions was adjusted using 0.1 M HNO₃ and 0.1 M NaOH. The pH measurements were conducted with a Mettler Toledo SevenMulti pH meter calibrated using pH 4, 7 and 10 buffer solutions.

0.1 M HNO₃ or 0.1 M NaOH was added to each of the lead solutions to prepare a series of 100 ppb lead solutions in a pH range of 3-8, and the resulting solution pH was measured in the pH studies. 0.1 g of melamine-formaldehyde polymer prepared in Example 1 was stirred in 25 mL of the stock metal solution (100 ppb) at different pH for 2 hours.

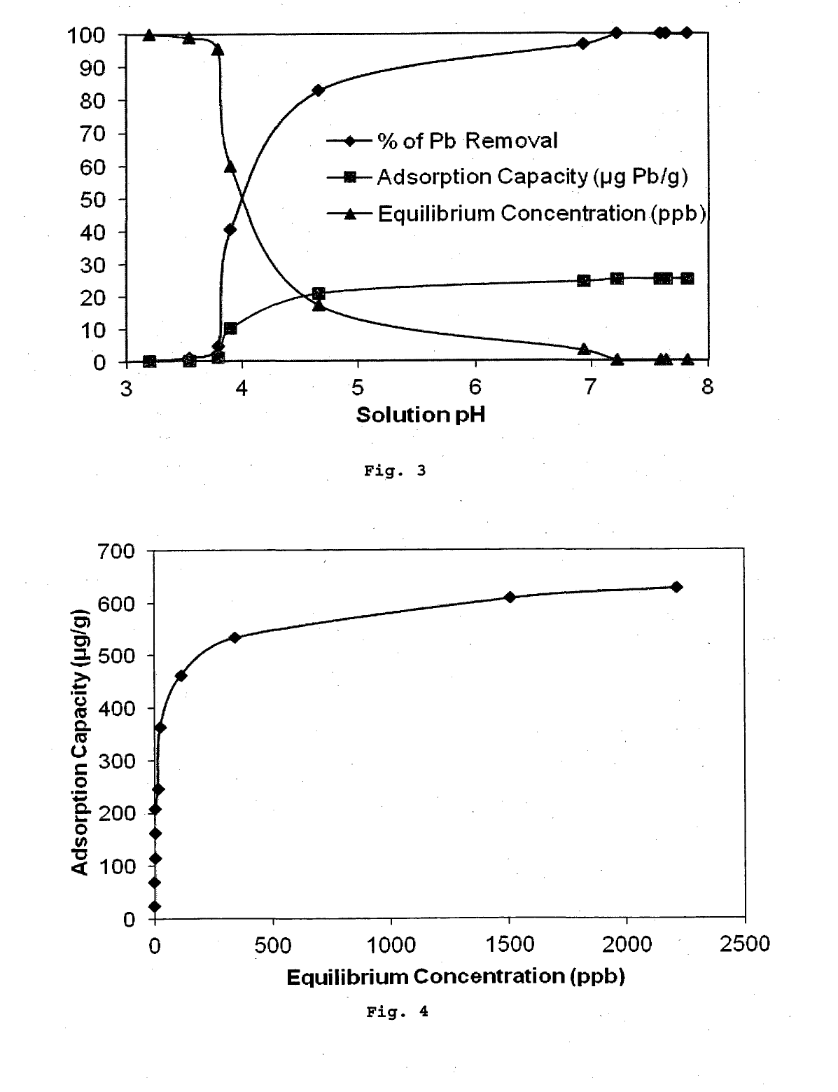

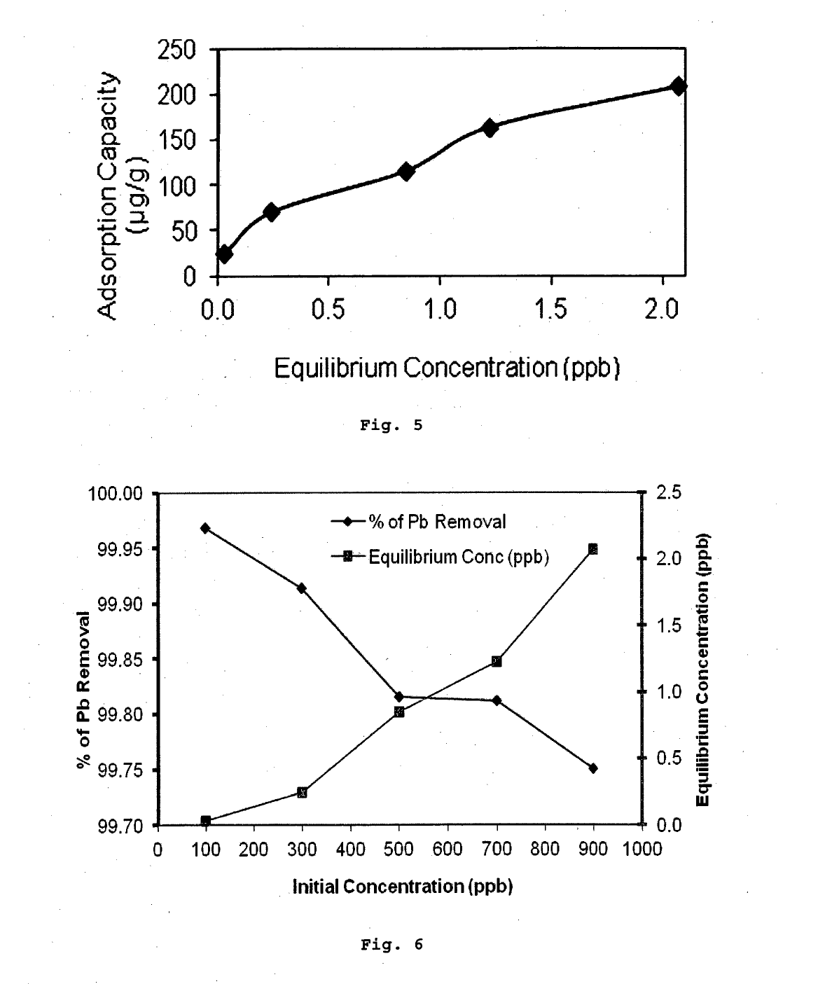

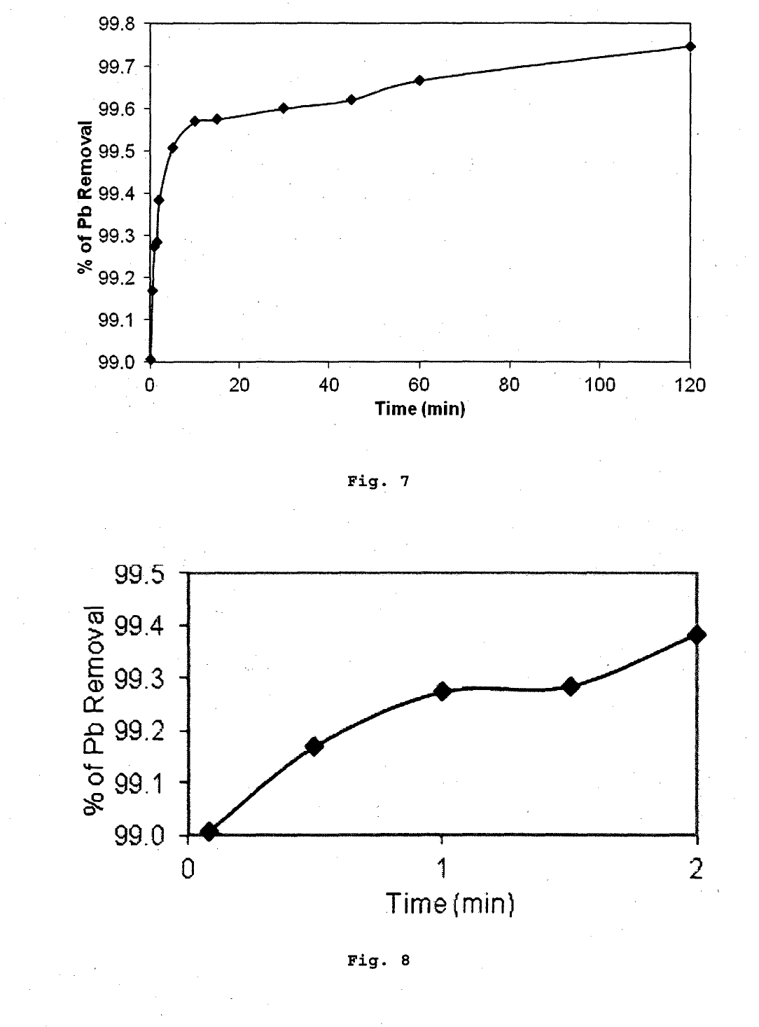

The effect of pH was examined in the range of 3.0-8.0. The desired pH was adjusted with the addition of dilute nitric acid. It was found that the melamine-formaldehyde polymer's adsorption capacity and metal removal efficiency were dependent on the pH of the solution (FIG. 3). At pH below 3.8, less than 1% of Pb present in the solution was removed. The removal efficiency was sharply increased as the pH increased to 3.8 and above. At the unadjusted pH value of the solution, which was −5.5, the removal efficiency reached >90%. As the pH increased further, the removal efficiency steadily increased to more than 99% above pH of −7.2.

The melamine-formaldehyde polymer's high density of amine groups can be protonated at low pH. Presumably, the protonated amine groups are not able to bind metals and thus decrease the polymer's ability to bind metals. At pHs in which the amines exist predominantly in free base form, i.e., unprotonated, (pH>5.0), the free amine groups in the melamine-formaldehyde polymer would be expected to have a stronger binding affinity with metals, leading to the efficient removal of metals from solution. This pH dependent affinity was demonstrated by the present study.

### Example 3

### Study on the Effect of Initial Lead Concentrations on Removal Efficiency

The effect of initial Pb concentrations was studied in the range between 100 and 5000 ppb at a pH of 5.5. The equilibrium concentrations of lead in the stock solutions were obtained after 2 hours of contact time between the lead solution and the melamine-formaldehyde polymer.

The data depicted in FIG. 4 demonstrates that as the equilibrium concentration of lead increases to −100 ppb, the incremental increase in adsorption capacity of the melamine-formaldehyde polymer becomes smaller.

The adsorption capacity reached a value 665 μg/g for the Pb solution with an initial concentration of 5000 ppb (corresponding to an equilibrium concentration of 2200 ppb).

For stock solutions containing 100-900 ppb Pb, detailed adsorption performance was studied at a pH of 5.5 (see FIG. 6). For the solution with an initial Pb concentration of 100 ppb, the melamine-formaldehyde polymer achieved 99.97% Pb removal, giving an equilibrium Pb concentration as low as 0.03 ppb. For the solution with a much higher initial Pb concentration of 900 ppb, the melamine-formaldehyde polymer attained 99.8% Pb removal, yielding an equilibrium Pb concentration of 2.1 ppb. These equilibrium concentrations are well below the current WHO and EPA acceptable limits of 15 ppb and 10 ppb, respectively. The melamine-formaldehyde polymer demonstrated a remarkable ability to remove lead to extremely low concentrations, which has not been observed with other adsorbents.

### Example 4

### Study of the Melamine-Formaldehyde Polymer's Lead Uptake Kinetics

The lead uptake kinetics of the melamine-formaldehyde polymer was studied with a solution with 100 ppb of Pb at a pH of 5.5. The study demonstrates that the melamine-formaldehyde polymer attained a removal efficiency of 99% of the lead present in the sample within 5 seconds (FIG. 8).

This removal efficiency compares favorably with chelating polymers, which are the fastest adsorbents reported in literature. Chelating polymers can reach equilibrium in 20-30 seconds. Other conventional absorbents can require anywhere from minutes to hours to reach equilibrium concentrations of the metal species.

The melamine-formaldehyde polymer's ability to quickly achieve equilibrium concentrations of the metal species in solution allows for cost-effective processes to be developed for industrial applications where metal extraction speeds are critical.

Without being bound by theory, it is believed that the rapid adsorption, high removal efficiency and extremely low equilibrium concentration of metal species can be attributed to the open porous structure, high surface area and high density of nitrogen groups present in the melamine-formaldehyde polymer. The mesoporous structure of the melamine-formaldehyde polymer can provide easy and rapid access to the nitrogen binding sites on and/or below the surface of the polymer.

Synthesized via the condensation of melamine and formaldehyde, the melamine-formaldehyde polymer consists of an extremely high density of nitrogen groups that can effectively chelate and strongly bind with transition metal ions. The figure below illustrates possible binding interactions between an idealized structure representing the melamine-formaldehyde polymers described herein and a lead species.

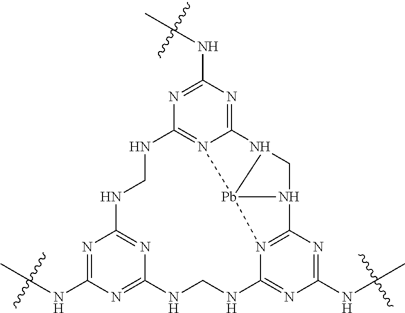

Since amine groups have very weak affinity for alkali and alkaline metals, the melamine-aldehyde polymers can selectively remove transition metals in the presence of Group I and II metal species. When mineral water (containing 4.90 ppm. Mg²⁺, 1.90 ppm K⁺, 14.50 ppm Ca²⁺, 8.50 ppm NaI was used in the preparation of a lead containing solution, the melamine-aldehyde polymer was able to selectively remove Pb from the sample as effectively as from a lead containing solution prepared from deionized water.

This demonstrates that not only can the melamine-aldehyde polymers described herein selectively remove transition metals from a liquid in the presence of Group I and II ions, but the polymer's metal extraction efficiency is unaffected by the presence of such ions in the liquid.

### Example 5

### Study Demonstrating the Removal of Additional Heavy Metals by the Melamine-Formaldehyde Polymer

Stock solutions of copper (100-3000 ppb), cadmium (25-100 ppb), and palladium (100-500 ppb) were prepared. Metal extraction was conducted in a similar fashion as described in Example 3. As demonstrated in Table 1 below, the melamine-formaldehyde polymer can remove copper, cadmium and palladium to extremely low equilibrium concentrations.

TABLE 1
Copper, Cadmium, and Palladium Removal.

| | | Initial | Final | | |
|---|---|---|---|---|---|
| | | Concentration | Concentration | Removal | Capacity |
| Entry | Metal | (ppb) | (ppb) | (%) | (μg/g) |
| 1 | Cu | 100 | 0.02 | 99.98 | 24.99 |
| 2 | Cu | 500 | 0.975 | 99.79 | 124.74 |
| 3 | Cu | 2000 | 307.4 | 84.23 | 421.16 |
| 4 | Cu | 3000 | 868.35 | 68.50 | 513.74 |
| 7 | Cu | 25 | 0.08 | 99.69 | 6.23 |
| 8 | Cd | 50 | 0.06 | 99.89 | 12.49 |
| 9 | Cd | 75 | 0.06 | 99.92 | 18.74 |
| 10 | Cd | 100 | 0.01 | 99.99 | 25.00 |
| 11 | Pd | 100 | 0.248 | 99.74 | 23.75 |
| 12 | Pd | 500 | 0.625 | 99.87 | 121.54 |

As can be seen in Table 1, the melamine-formaldehyde polymer can achieve equilibrium concentrations of 0.02 ppb for copper, of 0.01 ppb for cadmium, and 0.248 ppb for palladium. Furthermore, the melamine-formaldehyde polymer has a removal efficiency of almost 100%.

### Example 6

### Studies on Regenerating Melamine-Formaldehyde Polymer and Subsequent Extraction Efficiency

The metal-adsorbed melamine-formaldehyde polymer (0.1 g) was washed with 0.1 M HCl (3×5 mL). The melamine-formaldehyde polymer was further washed with deionized water (5×2.5 mL), and the filtrate was analyzed for the recovery of metal ions. The melamine-formaldehyde polymer was further treated with 0.2 M NaOH (3×2.5 mL), washed with deionized water until the filtrate was neutral, and then dried. The recycled melamine-formaldehyde polymer was employed in further equilibrium sorption studies.

Over 93% of lead that is bound by the melamine-formaldehyde polymer can be recovered upon treatment of the metal-adsorbed polymer with acid. The acid treated melamine-formaldehyde polymer can be then be reactivated for metal ion adsorption by washing with a dilute base solution.

Table 2 below demonstrates the ability to recycle the lead-adsorbed melamine-formaldehyde polymer by removing the lead bound to the polymer material. The lead-adsorbed melamine-formaldehyde polymer (100 mg) was initially exposed to 25 mL 100 ppb Pb solution.

TABLE 2
Recycling of Metal-Adsorbed Melamine-Formaldehyde Polymer.

| | Re- | Initial | Final | | Capac- |
|---|---|---|---|---|---|
| Recovery | cycle | Concentration | Concentration | Removal | ity |
| Method | Run | (ppb) | (ppb) | (%) | (μg/g) |
| 50 mM | 1 | 95.690 | 0.05 | 99.95 | 23.91 |
| HCl | 2 | 90.575 | 0.13 | 99.86 | 22.61 |
| | 3 | 95.755 | 0.12 | 99.87 | 23.91 |
| 5% | 1 | 95.690 | 0.065 | 99.93 | 23.91 |
| acetic | 2 | 90.575 | 0.325 | 99.83 | 22.61 |
| acid | 3 | 95.755 | 0.285 | 99.70 | 23.89 |

As can be seen from Table 2, using 50 mM HCl, 93.95% of Pb may be recovered from the lead-bound melamine-formaldehyde polymer.

Thus, the melamine-aldehyde polymer is not only useful for the removal of toxic heavy metals, but can also be used in the recovery of metals, particularly valuable metals, from liquids.

Using lead as an example, Table 2 below shows the percentage recovery of lead from a lead-bound melamine formaldehyde polymer (100 mg of melamine-formaldehyde polymer that was exposed to 25 mL of a 100 ppb Pb solution) that is treated with 3×5 mL of the indicated acid.

TABLE 3
Recovery of Pb from Metal-adsorbed
Melamine-Formaldehyde Polymer

| | Pb |
|---|---|
| Recovery | Recovery |
| Method | (%) |
| 25 mM HCl | 69.16 |
| 50 mM HCl | 93.95 |
| 100 mM HCl | 93.57 |
| 5% acetic acid | 75.78 |
| 10% acetic acid | 75.88 |

As illustrated in Table 3, up to 931 of the metal bound in the metal-adsorbed polymer can be recovered upon treatment with dilute acid. This demonstrates that the polymer can be used to efficiently recover metals from liquids.

### APPLICATIONS

The melamine-aldehyde polymers described herein have broad application in the areas of metal removal and retrieval from aqueous liquids, organic liquids, and combinations thereof. The polymers have a selective affinity for heavy metals and can be used to treat wastewater in industrial settings and in the purification of tap water, such as in point-of-use water purification/treatment devices that can require high-purity, without effecting the concentration of Group I and II metals.

The melamine-aldehyde polymers described herein can also be used as a means for the selective recovery and isolation of transition metals from liquids. Such a capability could find use in industrial settings for recovering unused and otherwise lost valuable metals from liquids.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1-25. (canceled)

26. A melamine-aldehyde polymer when used to reduce the amount of a metal in a liquid sample, wherein the polymer has pores with a volume in the range of about 1.5 to 5 cm³/g.

27. The polymer of claim 26, wherein the polymer has pore sizes in the range of about 2 nm to about 40 nm.

28. The polymer of claim 26, wherein the polymer has a BET surface area greater than about 400 m²/g.

29. The polymer of claim 26, wherein the polymer comprises melamine and aldehyde in a molar ratio of about 1:1.5 to about 1:2.

30. The polymer of claim 26, wherein the polymer is disposed onto a carrier suitable for water treatment or incorporated into a filtration device suitable for water treatment or disposed onto a carrier and incorporated into a filtration device suitable for water treatment.

31. A method of reducing the amount of a metal in a liquid sample, the method comprising the step of:
a. contacting the liquid sample with a polymer according to claim 26 thereby forming a polymer metal complex and a purified liquid sample,
wherein the amount of the metal in the purified liquid sample is lower than the amount of metal in the liquid sample.

32. The polymer metal complex of claim 31.

33. The method of claim 31, further comprising the step of:
b. separating the purified liquid sample and the polymer metal complex.

34. The method of claim 31, wherein the metal is a heavy metal, lead, copper, cadmium, palladium, or combinations thereof.

35. The method of claim 31, wherein the contacting occurs for at least 5 seconds, or at a pH greater than about 4.

36. The method of claim 31, wherein the amount of metal in the liquid sample is in an amount between 50 ppb to about 300,000 ppb.

27. The method of claim 31, wherein the amount of the metal in the purified liquid sample is reduced to an amount below about 50 ppb.

38. The method of claim 31, wherein the amount of the metal in the liquid sample is reduced by about 60% to about 99.99% after the step of contacting the liquid sample with the polymer according to claim 26.

39. The method of claim 31, wherein the amount of sodium, potassium, or calcium in the liquid sample is reduced by less than about 5% after the step of contacting the liquid sample with the polymer according to claim 26.

40. The method of claim 31, wherein the polymer is disposed onto a carrier suitable for liquid treatment or incorporated into a filtration device suitable for liquid treatment or disposed onto a carrier and incorporated into a filtration device suitable for liquid treatment.

41. The method of claim 31, further comprising the steps of:
c. contacting the polymer metal complex with an acid thereby forming a protonated polymer; and
d. contacting the protonated polymer with a base thereby regenerating the polymer according to claim 26.

42. A method for preparing a polymer according to claim 26, the method comprising the step of contacting melamine with an aldehyde thereby forming the polymer according to claim 26, wherein the step of contacting occurs at a temperature greater than 100° C. and a pressure greater than 100 kPa.

43. The method of claim 42, wherein the step of contacting occurs in a solvent is a polar aprotic solvent.

44. The method of claim 43, wherein the aldehyde is formaldehyde or a formaldehyde equivalent.
